(19) United States
(12) Patent Application Publication
(10) Pub. No.: US 2020/0311303 A1
(43) Pub. Date: Oct. 1, 2020

(54) METHODS, SYSTEMS, APPARATUSES AND DEVICES FOR FACILITATING USER PRIVACY USING ENCRYPTION BASED PSEUDONYMIZATION

(71) Applicant: Ruoyu Wang, JERICHO, NY (US)

(72) Inventor: Ruoyu Wang, JERICHO, NY (US)

(21) Appl. No.: 16/567,354

(22) Filed: Sep. 11, 2019

Related U.S. Application Data
(60) Provisional application No. 62/826,691, filed on Mar. 29, 2019.

(51) Int. Cl. G06F 21/62; H04L 29/06; H04L 9/08; G06F 21/60

(52) U.S. Cl. CPC G06F 21/6254; H04L 63/08; G06F 21/602; H04L 9/0891; H04L 9/0866

(57) ABSTRACT

Disclosed herein is a system for facilitating user privacy using encryption based pseudonymization, in accordance with some embodiments. Accordingly, the system may include a communication device configured for receiving a request to pseudonymize personal data associated with a user from a device. Further, the request may include credentials associated with the user. Further, the system may include a processing device configured for authenticating the user based on the credentials. Further, the processing device may be configured for verifying permissions associated with the request based on the authenticating of the user. Further, the processing device may be configured for pseudonymizing the personal data based on the verifying to obtain pseudonymized data. Further, the system may include a storage device configured for storing the pseudonymized data.

### FIELD OF THE INVENTION

Generally, the present disclosure relates to the field of data processing. More specifically, the present disclosure relates to methods, systems, apparatuses and devices for facilitating user privacy using encryption based pseudonymization.

### BACKGROUND

People hand out their personal data when they go shopping, apply for new jobs, subscribe to new services, etc. The data are not expected to be shared unless otherwise stated. However personal data breach is reported on a daily basis. The root cause could be internal intentional data leak or external hacking during the phase of data storage, processing or analytics. The present invention protects personal data from both directions.

Therefore, there is a need for improved methods, systems, apparatuses and devices for facilitating user privacy using encryption based pseudonymization that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating user privacy using encryption based pseudonymization, in accordance with some embodiments. Further, the method may include receiving, using a communication device, a request to pseudonymize personal data associated with a user from a device. Further, the request may include credentials associated with the user. Further, the method may include authenticating, using a processing device, the user based on the credentials. Further, the method may include verifying, using the processing device, permissions associated with the request based on the authenticating of the user. Further, the method may include pseudonymizing, using the processing device, the personal data based on the verifying to obtain pseudonymized data. Further, the method may include storing, using a storage device, the pseudonymized data.

Further disclosed herein is a system for facilitating user privacy using encryption based pseudonymization, in accordance with some embodiments. Accordingly, the system may include a communication device configured for receiving a request to pseudonymize personal data associated with a user from a device. Further, the request may include credentials associated with the user. Further, the system may include a processing device configured for authenticating the user based on the credentials. Further, the processing device may be configured for verifying permissions associated with the request based on the authenticating of the user. Further, the processing device may be configured for pseudonymizing the personal data based on the verifying to obtain pseudonymized data. Further, the system may include a storage device configured for storing the pseudonymized data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram representation of a system for facilitating user privacy using encryption based pseudonymization, in accordance with some embodiments.

FIG. 3 is a flowchart of a method for facilitating user privacy using encryption based pseudonymization, in accordance with some embodiments.

FIG. 4 is a flowchart of a method to facilitate pseudonymizing a personal data, in accordance with some embodiments.

FIG. 5 is a flowchart of a method to facilitate access personal data, in accordance with some embodiments.

FIG. 6 is a flowchart of a method to facilitate processing a personal data using the pseudonymized data, in accordance with some embodiments.

FIG. 7 is a flowchart of a method for facilitating user privacy using encryption based pseudonymization, in accordance with some exemplary embodiment.

FIG. 8 is an exemplary representation of a system for data controllers and processors to pseudonymize personal data in accordance with one or more implementations.

FIG. 9 is an exemplary flowchart of a method to process the requests from a service provider or a data processor in accordance with one or more implementations.

FIG. 10 is a software design paradigm of Keychain application in accordance with one or more implementations.

FIG. 11 is an exemplary flowchart of a method to perform a series of data processing or analytics while maintaining pseudonymization between two adjacent data processing or analytics in accordance with one or more implementations.

FIG. 12 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of systems and methods for facilitating user privacy using encryption based pseudonymization, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. iOS, Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

An encryption-based pseudonymization system for personal data protection is disclosed. Accordingly, the system may include a server-side computer system including one or more processors programmed to execute computer program instructions that, when executed, cause the server-side computer system to associate a unique identifier to an individual's personal data; authenticate a service provider, its service and/or users; check the permissions and privileges of a service provider, its service and/or users; manage the keys for encrypting and decrypting personal data; encrypt personal data; decrypt encrypted personal data; manage personal data privacy consents; grant the access to a key to encrypt and decrypt an individual's personal data; reject the access to a key to decrypt an individual's personal data; delete an individual's personal data; grant the access to exported data sets for pseudonymization; reject the access to exported data sets for pseudonymization; export selected or all user consents and associated crypto keys into a big data processing friendly format; cache keys to improve encryption and decryption performance; monitor the system's performance metrics; audit a user's consent grant or revoke history, a user's crypto key grant or revoke history and a user's keys access log; and analyze personal data.

Further, in some embodiments, the server-side computer system may be caused to replace an individual's personal identifiable information with a unique identifier, which may be assigned by a service provider. The unique identifier may be the index to the individual's personal data.

Further, in some embodiments, the server-side computer system may be caused to authenticate an Internet service using certificates, API keys, tokens, credentials or service identifier; authenticate a user of an Internet service using credentials or certificates; and authenticate a request from an Internet service using certificates, API keys, tokens.

Further, in some embodiments, the server-side computer system may be caused to check if a service provider, a service or a user has the permission or privilege to conduct the operation specified in the request.

Further, in some embodiments, the server-side computer system may be caused to manage keys for encryption and decryption. The key management may include key creation, key storage, key distribution, random number generation.

Further, in some embodiments, the server-side computer system may be caused to encrypt personal data with an individual's key, which may be configured to correspond to the data category the personal data belong to.

Further, in some embodiments, the server-side computer system may be caused to decrypt personal data with an individual's key, which may be configured to correspond to the data category the personal data belong to.

Further, in some embodiments, the server-side computer system may be caused to manage an individual's consents. The consent management may include managing the data categories, managing an individual's current consent and consent history, linking an encryption key to a data category.

Further, in some embodiments, the server-side computer system may be caused to grant the access to an individual's key based on the permission checks.

Further, in some embodiments, the server-side computer system may be caused to reject the access to an individual's key based on the permission checks.

Further, in some embodiments, the server-side computer system may be caused to delete an individual's personal data via erasing the individual's keys.

Further, in some embodiments, the server-side computer system may be caused to grant the access to the exported data sets for pseudonymization based on users' consents and data protection officers' decisions. The data sets may include users' consents and associated keys.

Further, in some embodiments, the server-side computer system may be caused to reject the access to the exported data sets for pseudonymization based on users' consents and data protection officers' decisions. The data sets may include users' consents and associated keys.

Further, in some embodiments, the server-side computer system may be caused to export selected or all data sets for pseudonymization into a big data processing friendly format. The data sets may include users' consents and associated keys.

Further, in some embodiments, the server-side computer system may be caused to cache the keys and purge the cache's content periodically.

Further, in some embodiments, the server-side computer system may be caused to monitor the system's performance metrics. The metrics comprise system utilization rates, encryption/decryption performance rates, data traffic statistics, system failure, etc.

Further, in some embodiments, the server-side computer system may be caused to audit a user's consent grant or revoke history, a user's crypto key grant or revoke history and a user's keys access log.

Further, in some embodiments, a method for performing a series of data processing or analytics while maintaining pseudonymization between two adjacent data processing or analytics is disclosed. Accordingly, the method being implemented by a server-side computer system comprising one or more processors executing computer system instructions that, when executed, perform the method. Further, the method may include de-pseudonymize the pseudonymized personal data with the exported pseudonymization data sets; invoke built-in or 3-rd party data processing or data analytics on the personal data; pseudonymize the processing or analytical results; write the processing or analytical results, which may be pseudonymized if containing personal identifiable information, to a persistent storage; and set the processing or analytical results, which may be pseudonymized if containing personal identifiable information, as new pseudonymized personal data.

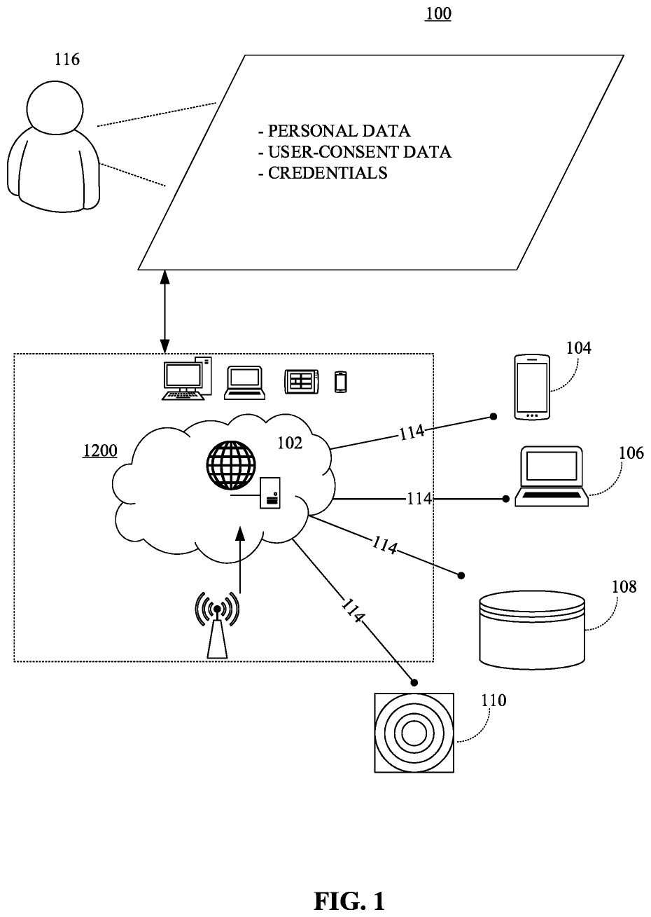

FIG. 1 is an illustration of an online platform 100 consistent with various embodiments of the present disclosure. By way of non-limiting example, the online platform 100 to facilitate user privacy using encryption based pseudonymization may be hosted on a centralized server 102, such as, for example, a cloud computing sever or an on premise sever. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 over a communication network 114, such as, but not limited to, the Internet. Further, users of the online platform 100 may include relevant parties such as, but not limited to, end users, administrators, service providers, service consumers, regulators and so on. Accordingly, in some instances, electronic devices operated by the one or more relevant parties may be in communication with the platform.

A user 116, such as the one or more relevant parties, may access online platform 100 through a web based software application or an internet based software application or browser. The web based software application may be embodied as, for example, but not be limited to, a website, a web application, a desktop application, and a mobile application compatible with a computing device 1200.

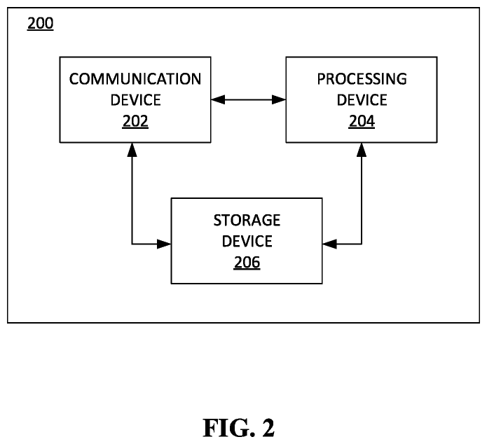

FIG. 2 is a block diagram representation of a system 200 for facilitating user privacy using encryption based pseudonymization, in accordance with some embodiments. Accordingly, the system 200 may include a communication device 202 configured for receiving a request to pseudonymize personal data associated with a user from a device. Further, the request may include credentials associated with the user. In some embodiments, the request may include user-consent data associated with the personal data.

Further, the system 200 may include a processing device 204 configured for authenticating the user based on the credentials. Further, in some embodiment, the authenticating of the user may be further based on authenticating protocols. Further, the authenticating protocols may include at least one of certificates, Application Programming Interface (API) keys, tokens, credentials, and OAuth.

Further, the processing device 204 may be configured for verifying permissions associated with the request based on the authenticating of the user. Further, the permissions may be defined by a service provider keychain system or any other permissioning system.

Further, the processing device 204 may be configured for pseudonymizing the personal data based on the verifying to obtain pseudonymized data. In some embodiment, the pseudonymizing of the personal data may be further based on pseudonymization data sets retrieved from a pseudonymization database. Further, in some embodiment, an individual data unit in the personal data may not be re-identified based on the pseudonymized data without additional information. Further, the pseudonymized data may be suitable for data analysis and data processing.

Further, the pseudonymization (“pseudo”, “pseudonym”), in an instance, may be a procedure by which one or more identifying fields within a dataset may be replaced by one or more artificial identifiers or pseudonyms. Further, purpose of the procedure may be to render the dataset less identifying and therefore to possibly lower user objections with regard to use of the personal data. Further, the Pseudonymized data in this form may be suitable for extensive analytics and processing. Further, Pseudonyms, in an instance, may possess varying degrees of anonymity, ranging from highly linkable public pseudonyms (for e.g. a link between the pseudonym and a human being may be publicly known or easy to discover), potentially linkable non-public pseudonyms (for e.g. a link may be known to some parties but may not publicly be disclosed), and unlinkable pseudonyms (for e.g. a link may not be known to parties and may not be determined).

Further, the system 200 may include a storage device 206 configured for storing the pseudonymized data.

In some embodiment, the processing device 204 may be further configured for categorizing the personal data based on the verifying permissions to obtain categorized personal data. Further, the processing device 204 may be configured for generating a crypto-key associated with the categorized personal data. Further, in some embodiments, the crypto-key may be used for encrypting the personal data and decrypting an encrypted personal data. Further, the processing device 204 may be configured for encrypting the categorized personal data using the crypto-key to obtain the pseudonymized data. Further, in some embodiments, the processing device 204 may be configured for deleting the crypto-key.

In some embodiments, the communication device 202 may be further configured for receiving an access request from a user device to access the personal data associated with the user. Further, the processing device 204 may be configured for auditing the access request based on at least one of a consent state of the user and an authorization state of a data protection officer. Further, the processing device 204 may be configured for generating reports based on the auditing. Further, the processing device 204 may be configured for granting an access to the crypto-key based on the reports.

In some embodiments, the storage device 206 may be further configured for retrieving pseudonymization data sets from a pseudonymization database. Further, the storage device 206 may be configured for storing pseudonymized analytical results in a database. Further, the processing device 204 may be configured for de-pseudonymizing the pseudonymized data using the pseudonymization data sets to obtain de-pseudonymized data. Further, the processing device 204 may be configured for performing data analysis on the de-pseudonymized data to obtain analytical results. Further, the processing device 204 may be configured for examining the analytical results to identify the personal data in the analytical results. Further, the processing device 204 may be configured for pseudonymizing the analytical results based on the examining to obtain the pseudonymized analytical results.

In further embodiments, a system 200 may be configured for facilitating user privacy using encryption based pseudonymization. Accordingly, the system 200 may include a communication device 202 configured for receiving a request to pseudonymize personal data associated with a user from a device. Further, the request may include credentials associated with the user.

Further, the system 200 may include a processing device 204 configured for authenticating the user based on the credentials.

Further, the processing device 204 may be configured for verifying permissions associated with the request based on the authenticating of the user.

Further, the processing device 204 may be configured for analyzing the personal data to obtain analytical results.

Further, the processing device 204 may be configured for pseudonymizing the personal data and the analytical results based on the verifying to obtain pseudonymized data.

Further, a storage device 206 may be configured for storing the pseudonymized data.

Further, the communication device 202 is configured for receiving a user request to delete the pseudonymized data and the processing device 204 is further configured for deleting the pseudonymized data based on the user request.

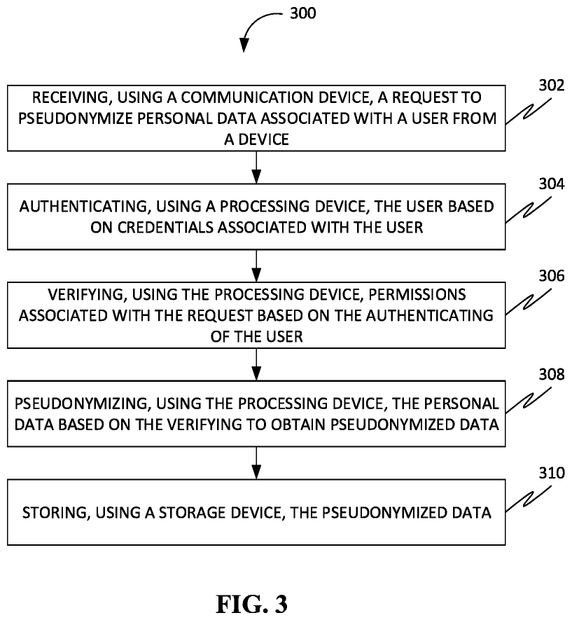

FIG. 3 is a flowchart of a method 300 for facilitating user privacy using encryption based pseudonymization, in accordance with some embodiments. Further, at 302, the method 300 may include receiving, using a communication device (such as the communication device 202), a request to pseudonymize personal data associated with a user from a device. Further, the request may include credentials associated with the user.

Further, at 304, the method 300 may include authenticating, using a processing device (such as the processing device 204), the user based on the credentials. In some embodiment, the authenticating of the user may be further based on authenticating protocols. Further, the authenticating protocols may include at least one of certificates, Application Programming Interface (API) keys, tokens, credentials, and OAuth.

Further, at 306, the method 300 may include verifying, using the processing device, permissions associated with the request based on the authenticating of the user.

Further, at 308, the method 300 may include pseudonymizing, using the processing device, the personal data based on the verifying to obtain pseudonymized data. Further, in some embodiment, an individual data unit in the personal data cannot be re-identified based on the pseudonymized data without additional information. Further, the pseudonymized data may be suitable for data analysis and data processing. Further, in some embodiment, the pseudonymizing the personal data may be further based on pseudonymization data sets retrieved from a pseudonymization database.

Further, at 310, the method 300 may include storing, using a storage device (such as the storage device 206), the pseudonymized data.

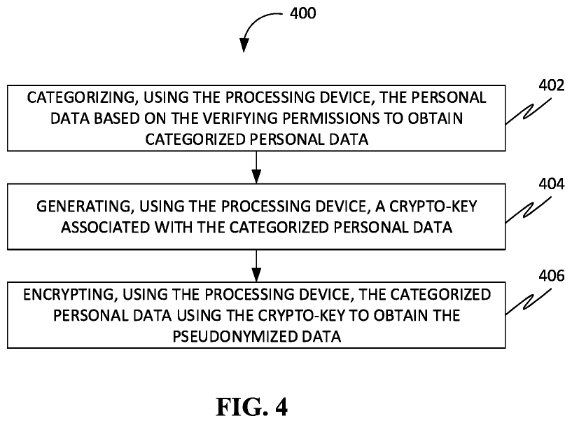

FIG. 4 is a flowchart of a method 400 to facilitate the pseudonymizing the personal data, in accordance with some embodiments. Accordingly, at 402, the method 400 may include categorizing, using the processing device, the personal data based on the verifying permissions to obtain categorized personal data.

Further, at 404, the method 400 may include generating, using the processing device, a crypto-key associated with the categorized personal data. Further, the crypto-key may be used for encrypting the personal data and decrypting an encrypted personal data.

Further, at 406, the method 400 may include encrypting, using the processing device, the categorized personal data using the crypto-key to obtain the pseudonymized data. Further, in some embodiments, the method may include deleting, using the processing device, the crypto-key.

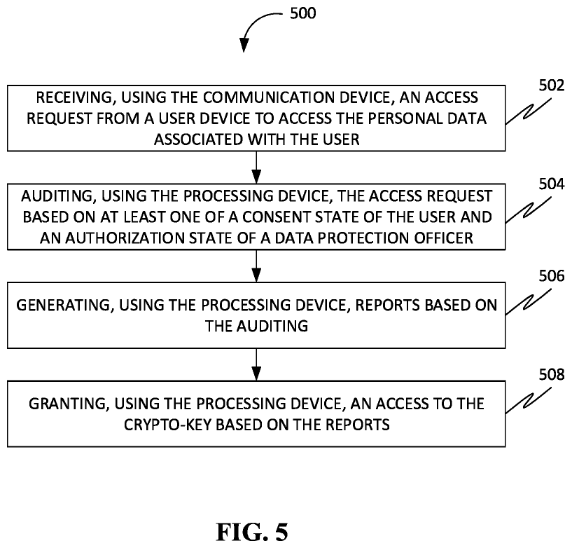

FIG. 5 is a flowchart of a method 500 to facilitate access the personal data, in accordance with some embodiments. Accordingly, at 502, the method 500 may include receiving, using the communication device, an access request from a user device to access the personal data associated with the user.

Further, at 504, the method 500 may include auditing, using the processing device, the access request based on at least one of a consent state of the user and an authorization state of a data protection officer.

Further, at 506, the method 500 may include generating, using the processing device, reports based on the auditing.

Further, at 508, the method 500 may include granting, using the processing device, an access to the crypto-key based on the reports.

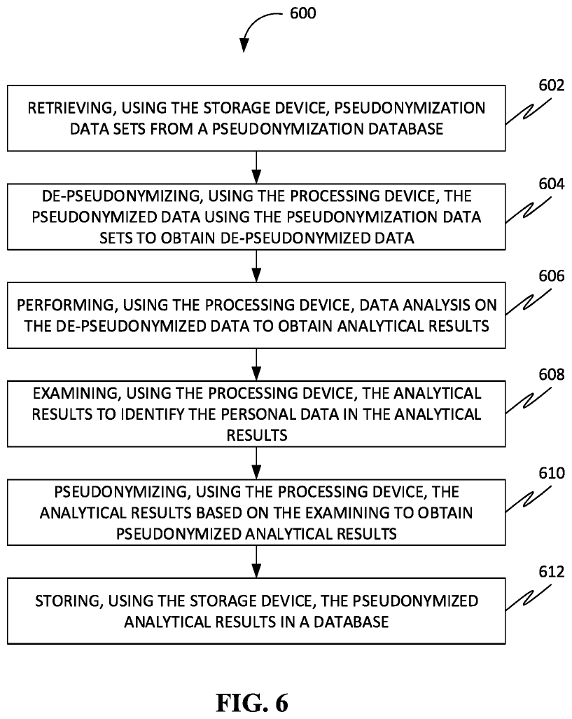

FIG. 6 is a flowchart of a method 600 to facilitate processing the personal data using the pseudonymized data, in accordance with some embodiments. Accordingly, at 602, the method 600 may include retrieving, using the storage device, pseudonymization data sets from a pseudonymization database.

Further, at 604, the method 600 may include de-pseudonymizing, using the processing device, the pseudonymized data using the pseudonymization data sets to obtain de-pseudonymized data.

Further, at 606, the method 600 may include performing, using the processing device, data analysis on the de-pseudonymized data to obtain analytical results.

Further, at 608, the method 600 may include examining, using the processing device, the analytical results to identify the personal data in the analytical results.

Further, at 610, the method 600 may include pseudonymizing, using the processing device, the analytical results based on the examining to obtain pseudonymized analytical results.

Further, at 612, the method 600 may include storing, using the storage device, the pseudonymized analytical results in a database.

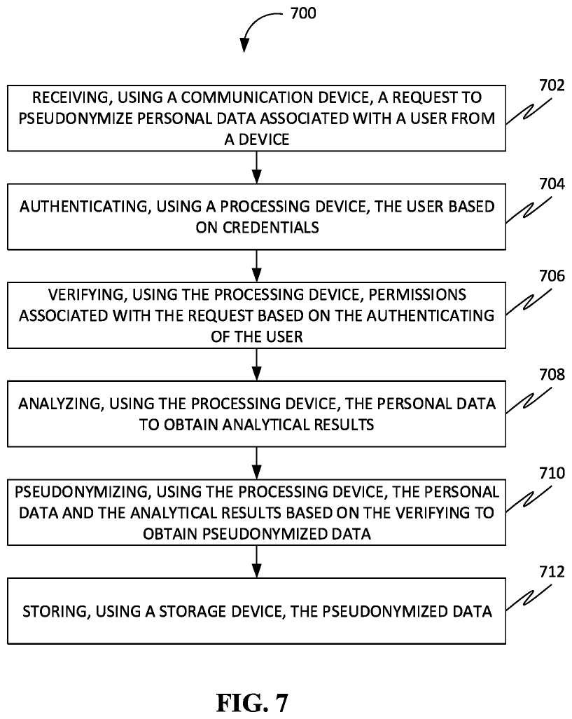

FIG. 7 is a flowchart of a method 700 for facilitating user privacy using encryption based pseudonymization, in accordance with some exemplary embodiment. Accordingly, at 702, the method 700 may include receiving, using a communication device (such as the communication device 202), a request to pseudonymize personal data associated with a user from a device. Further, the request may include credentials associated with the user.

Further, at 704, the method 700 may include authenticating, using a processing device (such as the processing device 204), the user based on the credentials.

Further, at 706, the method 700 may include verifying, using the processing device, permissions associated with the request based on the authenticating of the user.

Further, at 708, the method 700 may include analyzing, using the processing device, the personal data to obtain analytical results.

Further, at 710, the method 700 may include pseudonymizing, using the processing device, the personal data and the analytical results based on the verifying to obtain pseudonymized data.

Further, at 712, the method 700 may include storing, using a storage device, the pseudonymized data.

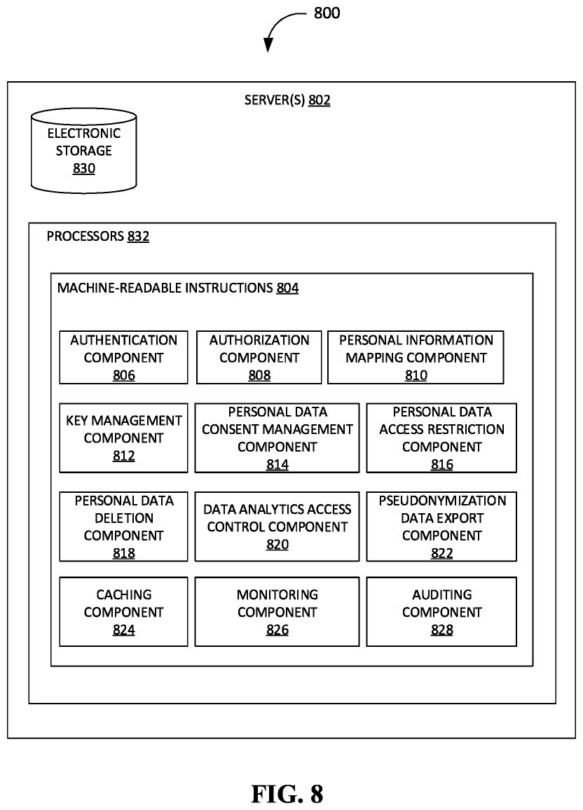

FIG. 8 is an exemplary representation of a system 800 for data controllers and processors to pseudonymize personal data in accordance with one or more implementations. In some implementation system 800 may include one or more servers 802.

Server(s) 802 may include electronic storage 830, one or more processor(s) 832, and/or other components. Server(s) 802 may be configured to execute machine-readable instructions 804. The machine-readable instructions 804 may include one or more of an authentication component 806, an authorization component 808, a personal information mapping component 810, a key management component 812, a personal data consent management component 814, a personal data access restriction component 816, a personal data deletion component 818, a data analytics access control component 820, a pseudonymization data export component 822, a caching component 824, a monitoring component 826, an auditing component 828 and/or other machine-readable instruction components.

The authentication component 806 may be configured to authenticate the service providers, their services and/or their users. The authentication protocols may include but not limited to certificates, API keys, tokens, credentials, OAuth.

The authorization component 808 may be configured to check the rights, privileges and/or permissions of the service providers, their services and/or their users.

The personal information mapping component 810 may be configured to receive a unique identifier from a service provider or a service, which is used to identify an individual and associate the identifier with any information related to the individual in the system.

The key management component 812 may be configured to create, store and manage keys, encrypt and decrypt data, generate random numbers, protect encrypted data integrity, and other management or cryptographic functions.

The personal data consent management component 814 may be configured to store all personal data categories and users' selections on how they would like the system to respect their privacy. A crypto key associated with each data category is created when a user is created in the system. Personal data is encrypted with the key for the data category the personal data belong to. A user's personal data is considered pseudonymized upon the completion of encryption.

The personal data access restriction component 816 may be configured to determine if a user's key should be handed out to decrypt the user's data based on the user's consent settings.

The personal data deletion component 818 may be configured to delete a user's crypto key. Once the key is deleted, all encrypted personal data are effectively deleted as they cannot be decrypted anymore.

The data analytics access control component 820 may be configured to grant the access to exported data set to data processors by the office of data protection officer or reject the access.

The pseudonymization data export component 822 may be configured to periodically export selected or all data sets for pseudonymization into a big data processing friendly format. The data processing pipelines can perform further encryption and decryption with the exported data set, which may include users' consents, corresponding authorized keys and other necessary information.

The caching component 824 may be configured to provide multiple layers of cache to achieve high performance and low latency. The cache may have a very short expiration time and its content may be purged periodically.

The monitoring component 826 may be configured to provide extensive metrics on different dashboards.

The auditing component 828 may be configured to examine a user's consents' states and change histories, a user's crypto key grant or revoke history, a user's key access history and generate reports.

Processor(s) 832 may include one or more of digital processors, an analog processor, a digital circuit designed to process information, an analog circuit designed to process information, a state machine, and/or other mechanisms for electronically processing information. The processor(s) 832 may be configured to execute machine-readable instruction components 806, 808, 810, 812, 814, 816, 818, 820, 822, 824, 826, 828, and/or other machine-readable instruction components by software, hardware, firmware and/or other mechanisms for configuring processing capabilities on processor(s) 832.

Electronic storage 830 may comprise non-transitory storage media that stores information electronically. It may include one or more of a local storage, a network-based storage, a cloud-based storage and/or other mechanisms for data storage.

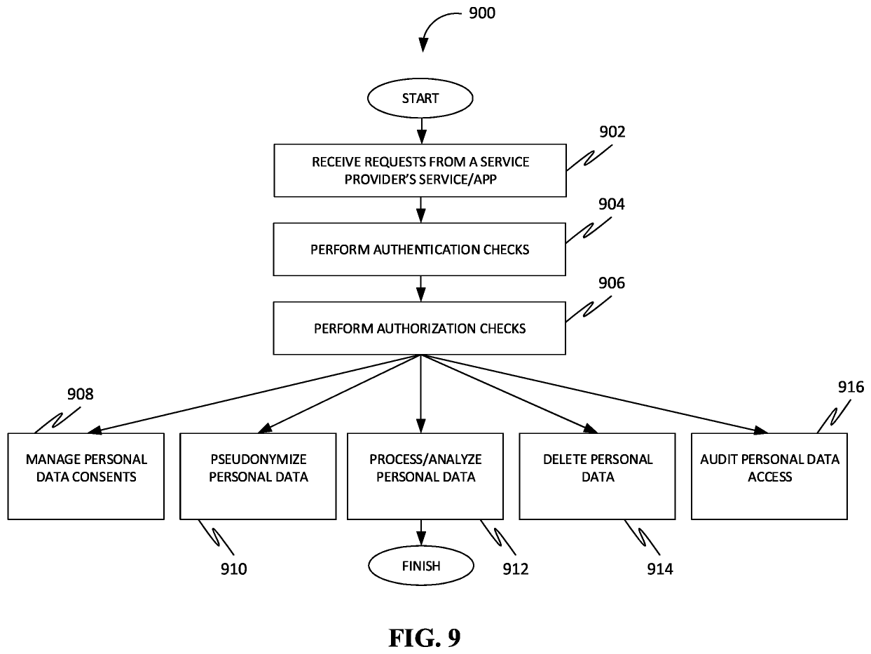

FIG. 9 is an exemplary flowchart of a method 900 to process the requests from a service provider or a data processor in accordance with one or more implementations. The operations of method 900 presented are intended to be illustrative. In some implementations method 900 may be accomplished with one or more additional operations not described, and/or without one or more of the operations discussed. Additionally, the order in which the operations of method 900 are illustrated in FIG. 9 and described below is not intended to be limiting.

In some implementations, one or more operations of method 900 may be implemented in one or more processing devices. The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900.

At an operation 902, the system receives requests from a service provider's service or app to handle personal data. Operation 902 may be performed by one or more hardware processors configured to execute a machine-readable instruction component, in accordance with one or more implementation.

At an operation 904, the credentials within the requests may be checked to ensure they are from valid sources. Operation 904 may be performed by one or more hardware processors configured to execute a machine-readable instruction component, in accordance with one or more implementations.

At an operation 906, the permissions associated with the requests or any fields in the requests may be checked. The permissions may be defined by the service providers, Keychain system or any other permissioning system. Operation 906 may be performed by one or more hardware processors configured to execute a machine-readable instruction component, in accordance with one or more implementations.

At an operation 908, personal data categories and user consents are managed or queried. Operation 908 may be performed by one or more hardware processors configured to execute a machine-readable instruction component, in accordance with one or more implementations.

At an operation 910, a unique identifier is associated with an individual's personal data. The personal data may be categorized and encrypted based on the categories. Operation 910 may be performed by one or more hardware processors configured to execute a machine-readable instruction component, in accordance with one or more implementations.

At an operation 912, personal data may be processed or analyzed under authorization from users and/or data protection officers. Combined with pseudonymization data set, the personal data may be decrypted and re-encrypted during the data analytics pipeline. The plaintext should only reside in the computer memory or momentarily on a hard drive. So, the personal data are still pseudonymized to data processors or analysts. Operation 912 may be performed by one or more hardware processors configured to execute a machine-readable instruction component, in accordance with one or more implementations.

At an operation 914, personal data may be deleted as per a user's request. The keys used to encrypt the personal data should be deleted. The encrypted personal data cannot be decrypted and are effectively deleted. Operation 914 may be performed by one or more hardware processors configured to execute a machine-readable instruction component, in accordance with one or more implementations.

At an operation 916, personal data access is audited against a user's consent state and change history and data protection officer's authorization. Their timelines may be compared, and reports may be generated. Operation 916 may be performed by one or more hardware processors configured to execute a machine-readable instruction component, in accordance with one or more implementations.

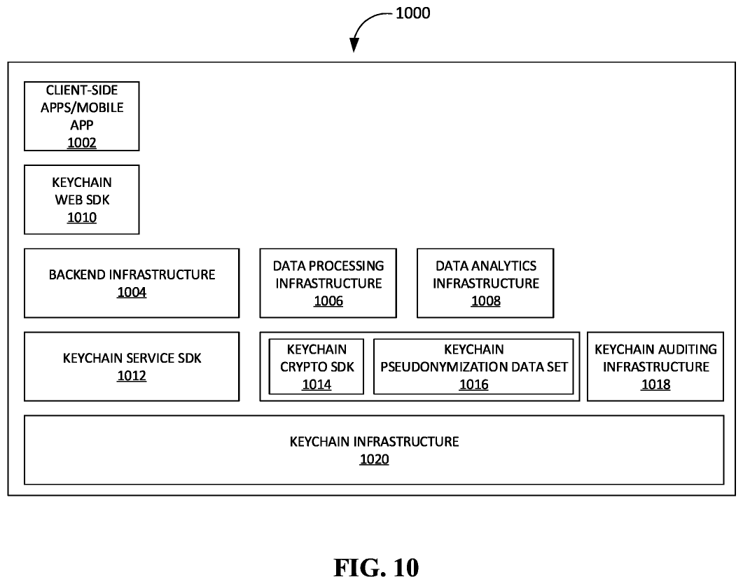

FIG. 10 is a software design paradigm 1000 of Keychain application in accordance with one or more implementations.

The design paradigm 1000 does not restrict clients how they want to use keychain system. It only serves the purpose to help client understand Keychain system.

A client's apps, services and its infrastructures communicate with Keychain infrastructure via various SDKs. A client-side app 1002 uses Keychain Web SDK 1010 to talk to a backend service 1004. A backend service 1004 uses Keychain Service SDK 1012. Data processing infrastructure 1006 and Data analytics infrastructure 1008 rely on Keychain crypto SDK 1014 and Keychain pseudonymization data set 1016.

Keychain auditing infrastructure 1018 aggregates the consent changes or other authorization changes to show if personal data handling is compliant with regulations.

Keychain infrastructure 1020 implements most server-side features of machine-readable instruction component 806, 808, 810, 812, 814, 816, 818, 820, 822, 824, 826 and 828 in FIG. 8.

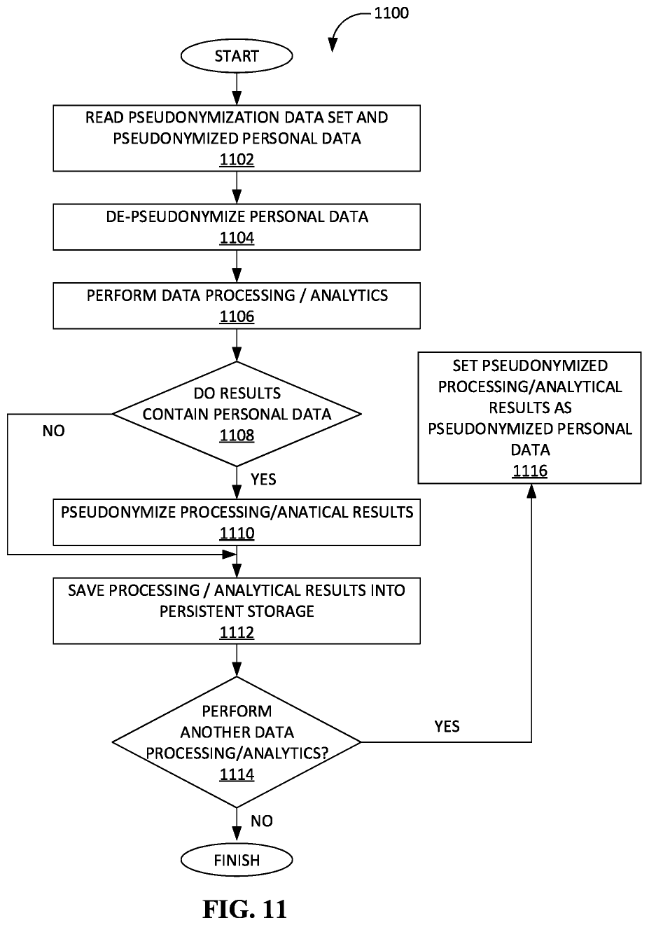

FIG. 11 is an exemplary flowchart of a method 1100 to perform a series of data processing or analytics while maintaining pseudonymization between two adjacent data processing or analytics in accordance with one or more implementations. The operations of method 1100 presented are intended to be illustrative. In some implementations method 1100 may be accomplished with one or more additional operations not described, and/or without one or more of the operations discussed. Additionally, the order in which the operations of method 1100 are illustrated in FIG. 11 and described below is not intended to be limiting.

In some implementations, one or more operations of method 1100 may be implemented in one or more processing devices. The one or more processing devices may include one or more devices executing some or all of the operations of method 1100 in response to instructions stored electronically on an electronic storage medium. The one or more processing devices may include one or more devices configured through hardware, firmware, and/or software to be specifically designed for execution of one or more of the operations of method 1100.

At an operation 1102, the system reads pseudonymization data sets and pseudonymized personal data. Operation 1102 may be performed by one or more hardware processors configured to execute a machine-readable instruction component, in accordance with one or more implementation.

At an operation 1104, pseudonymized personal data may be de-pseudonymized with pseudonymization data sets. Operation 1104 may be performed by one or more hardware processors configured to execute a machine-readable instruction component, in accordance with one or more implementation.

At an operation 1106, personal data are processed or analyzed. Operation 1106 may be performed by one or more hardware processors configured to execute a machine-readable instruction component, in accordance with one or more implementation.

At an operation 1108, decide if the processing or analytical results contains personal data. If yes, proceed to operation 1110. If no, proceed to operation 1112. Operation 1108 may be performed by one or more hardware processors configured to execute a machine-readable instruction component, in accordance with one or more implementation.

At an operation 1110, pseudonymize the processing or analytical results again. Operation 1110 may be performed by one or more hardware processors configured to execute a machine-readable instruction component, in accordance with one or more implementation.

At an operation 1112, save the pseudonymized processing or analytical results on a persistent storage. Operation 1112 may be performed by one or more hardware processors configured to execute a machine-readable instruction component, in accordance with one or more implementation.

At an operation 1114, decide if another processing or analytics operation would be performed. If no, exit the method with the results. If yes, proceed to operation 1116. Operation 1114 may be performed by one or more hardware processors configured to execute a machine-readable instruction component, in accordance with one or more implementation.

At an operation 1116, set pseudonymized processing or analytical results from operation 1110 as new pseudonymized personal data, which would be fed back to operation 1102 along with original pseudonymization data sets. Operation 1116 may be performed by one or more hardware processors configured to execute a machine-readable instruction component, in accordance with one or more implementation.

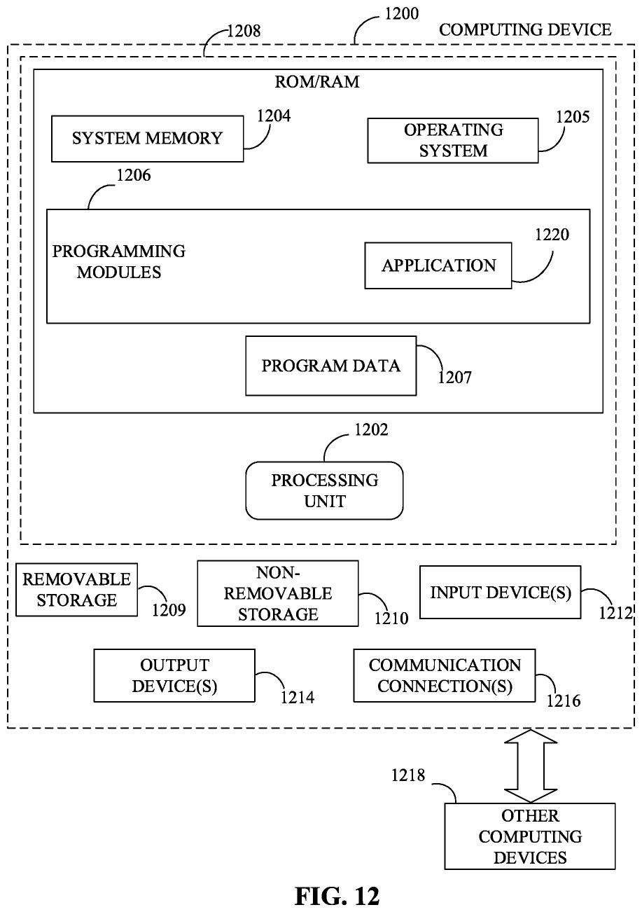

With reference to FIG. 12, a system consistent with an embodiment of the disclosure may include a computing device or cloud service, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random-access memory (RAM)), non-volatile (e.g. read-only memory (ROM)), flash memory, or any combination. System memory 1204 may include operating system 1205, one or more programming modules 1206, and may include a program data 1207. Operating system 1205, for example, may be suitable for controlling computing device 1200's operation. In one embodiment, programming modules 1206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and non-volatile, removable and non-removable media implemented in any method or technology for storage of information, such as computer-readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, a location sensor, a camera, a biometric sensor, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g., application 1220 such as a media player) may perform processes including, for example, one or more stages of methods, algorithms, systems, applications, servers, databases as described above. The aforementioned process is an example, and processing unit 1202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating user privacy using encryption based pseudonymization, wherein the method comprises:
receiving, using a communication device, a request to pseudonymize personal data associated with a user from a device, wherein the request comprises credentials associated with the user;
authenticating, using a processing device, the user based on the credentials;
verifying, using the processing device, permissions associated with the request based on the authenticating of the user;
pseudonymizing, using the processing device, the personal data based on the verifying to obtain pseudonymized data; and
storing, using a storage device, the pseudonymized data.

2. The method of claim 1, wherein the authenticating of the user is further based on authenticating protocols, wherein the authenticating protocols comprise at least one of certificates, Application Programming Interface (API) keys, tokens, credentials, and OAuth.

3. The method of claim 1, wherein an individual data unit in the personal data cannot be re-identified based on the pseudonymized data without additional information, wherein the pseudonymized data is suitable for data analysis and data processing.

4. The method of claim 1, wherein the pseudonymizing the personal data is further based on pseudonymization data sets retrieved from a pseudonymization database.

5. The method of claim 1, wherein the pseudonymizing further comprises:
categorizing, using the processing device, the personal data based on the verifying permissions to obtain categorized personal data;
generating, using the processing device, a crypto-key associated with the categorized personal data; and
encrypting, using the processing device, the categorized personal data using the crypto-key to obtain the pseudonymized data.

6. The method of claim 5, wherein the crypto-key is used for encrypting the personal data and decrypting an encrypted personal data.

7. The method of claim 5 further comprising deleting, using the processing device, the crypto-key.

8. The method of claim 5, wherein the method comprises:
receiving, using the communication device, an access request from a user device to access the personal data associated with the user;
auditing, using the processing device, the access request based on at least one of a consent state of the user and an authorization state of a data protection officer;
generating, using the processing device, reports based on the auditing; and
granting, using the processing device, an access to the crypto-key based on the reports.

9. The method of claim 1, wherein the method further comprises:
retrieving, using the storage device, pseudonymization data sets from a pseudonymization database;
de-pseudonymizing, using the processing device, the pseudonymized data using the pseudonymization data sets to obtain de-pseudonymized data;
performing, using the processing device, data analysis on the de-pseudonymized data to obtain analytical results;
examining, using the processing device, the analytical results to identify the personal data in the analytical results;
pseudonymizing, using the processing device, the analytical results based on the examining to obtain pseudonymized analytical results; and
storing, using the storage device, the pseudonymized analytical results in a database.

10. A method for facilitating user privacy using encryption based pseudonymization, wherein the method comprises:
receiving, using a communication device, a request to pseudonymize personal data associated with a user from a device, wherein the request comprises credentials associated with the user;
authenticating, using a processing device, the user based on the credentials;
verifying, using the processing device, permissions associated with the request based on the authenticating of the user;
analyzing, using the processing device, the personal data to obtain analytical results;
pseudonymizing, using the processing device, the personal data and the analytical results based on the verifying to obtain pseudonymized data; and
storing, using a storage device, the pseudonymized data.

11. A system for facilitating user privacy using encryption based pseudonymization, wherein the system comprises:
a communication device configured for:
receiving a request to pseudonymize personal data associated with a user from a device, wherein the request comprises credentials associated with the user;
a processing device configured for:
authenticating the user based on the credentials;
verifying permissions associated with the request based on the authenticating of the user;
pseudonymizing the personal data based on the verifying to obtain pseudonymized data; and
a storage device configured for storing the pseudonymized data.

12. The system of claim 11, wherein the authenticating of the user is further based on authenticating protocols, wherein the authenticating protocols comprise at least one of certificates, Application Programming Interface (API) keys, tokens, credentials, and OAuth.

13. The system of claim 11, wherein an individual data unit in the personal data cannot be re-identified based on the pseudonymized data without additional information, wherein the pseudonymized data is suitable for data analysis and data processing.

14. The system of claim 11, wherein the pseudonymizing the personal data is further based on pseudonymization data sets retrieved from a pseudonymization database.

15. The system of claim 11, wherein the processing device is further configured for:
categorizing the personal data based on the verifying permissions to obtain categorized personal data;
generating a crypto-key associated with the categorized personal data; and
encrypting the categorized personal data using the crypto-key to obtain the pseudonymized data.

16. The system of claim 15, wherein the crypto-key is used for encrypting the personal data and decrypting an encrypted personal data.

17. The system of claim 15, wherein the processing device is further configured for deleting the crypto-key.

18. The system of claim 15, wherein the communication device is further configured for receiving an access request from a user device to access the personal data associated with the user; and
the processing device is further configured for:
auditing the access request based on at least one of a consent state of the user and an authorization state of a data protection officer;
generating reports based on the auditing; and
granting an access to the crypto-key based on the reports.

19. The system of claim 11, wherein the storage device is further configured for:
retrieving pseudonymization data sets from a pseudonymization database; and
storing pseudonymized analytical results in a database; and
the processing device is further configured for:
de-pseudonymizing the pseudonymized data using the pseudonymization data sets to obtain de-pseudonymized data;
performing data analysis on the de-pseudonymized data to obtain analytical results;
examining the analytical results to identify the personal data in the analytical results; and
pseudonymizing the analytical results based on the examining to obtain the pseudonymized analytical results.

20. The system of claim 1 wherein the communication device is further configured for receiving a user request to delete the pseudonymized data; and
the processing device is further configured for deleting the pseudonymized data based on the user request.
